(19) United States
(12) Patent Application Publication
(10) Pub. No.: US 2020/0387924 A1
(43) Pub. Date: Dec. 10, 2020

(54) GEOGRAPHIC POLITICAL SCIENCE TARGETED COMMUNICATIONS AND DATA PLATFORM

(71) Applicant: IQM Corporation, New York, NY (US)

(72) Inventor: Bhargav V. PATEL, Mineola, NY (US)

(21) Appl. No.: 16/805,249

(22) Filed: Feb. 28, 2020

Related U.S. Application Data
(60) Provisional application No. 62/811,969, filed on Feb. 28, 2019.

(51) Int. Cl. G06Q 30/02; H04L 29/08; G06N 5/04; G06N 20/00; G06F 21/62

(52) U.S. Cl. CPC G06Q 30/0242; H04L 67/306; H04L 67/18; G06Q 30/0201; G06Q 30/0205; G06Q 30/0269; G06F 40/279; G06N 20/00; G06F 21/6254; H04L 67/26; G06Q 30/0248; G06Q 30/0273; G06Q 2230/00; G06N 5/043

(57) ABSTRACT

A system that de-identifies personally identifiable information, translate it into segments and deliver relevant content based on relevant segments and auto-correct itself. User data gets ingested in the platform by direct system integration or partner's data integration. Generates a relevant segment from multi-touchpoint attributes such as location visitation, media consumption, series of media consumption, etc. Match relevant segment from the content delivery system and score the demand generated segments and create a matching score in real-time. Based on the highest matched score generated by the system, the system pushes relevant content in real-time. Optimizes content based on NLP and classification of the content. Generate a de-identifiable key for the user to map with segments and deliver content. Generate segments like Geographical segments, Political Issues, Political Boundaries (constitutional boundaries), Technology, Voter profile, Demographics, Behaviours, and interests, etc from multiple content delivery interaction at the unique de-identifiable key level in realtime.

### CROSS-REFERENCE TO RELATED APPLICATION

This application claims priority to U.S. Provisional Patent Application Ser. No. 62/811,969, entitled “METHODS AND SYSTEMS FOR GEOGRAPHIC POLITICAL SCIENCE TARGETED COMMUNICATIONS AND DATA PLATFORM,” filed on Feb. 28, 2019, the contents of which are hereby incorporated herein in their entirety by this reference.

### TECHNICAL FIELD

The invention is generally related to the field of targeted communications and in particular geographic political science targeted communications and Data platform.

### BACKGROUND

Associating a data point to an end user profile and a means to target advertisements to the end user is well known. It is also well understood and documented by those skilled in the art that political ads can be targeted to an end user by associating web-based user profile data such as geographic, demographic, voter record data, device data and other personal, ambient, derivative and other user data points, which are associated to an end users voter profile for the purpose of advertising and content targeting. While modern advertising platforms have been used for behavioural targeting for decades, there is a need to provide the solution of targeting political districts and the ability to customize content based on voter sentiment and applied political science data, and the capability of delivering in multiple media formats including physical signage, mailers, telephonic, email, social media and digital to a fixed audience of voters within a specified demographic. There is a need to solve a large and pervasive set of problems for managers, candidates, and others by enabling the ability to understand, parse and execute communications based on geographic and applied political science data for the purpose of mobilizing and appealing to a voter base and to gain additional supportive constituents through the use of data and information to target communications and political activities, messaging and communications to voter based constituents.

This invention enables better data management and deployable communications and advertisements through scalable and automated systems while informing political campaigns and political activism through information and understanding the communications that are most likely to align the proponents of political causes and candidates. Illustrated in this invention is an effective applied political science and data driven campaign and political management platform that can target, reach and motivate voters to act. The system provides an automated process for understanding voter sentiment and communications data that gives campaign managers, organizations, candidates, media and the governments that they serve the ability to better predict voter behaviour and voter response to tailored communications messaging through the creation of a more responsive political platform that activates and empowers multi-channel media campaigns with real-time data-based applications.

In the internet age, information is more readily available than ever, which in turn creates a wide range of sources where people are able to expose themselves to various points of view. This type of information proliferation is healthy and ultimately creates a more informed electorate. A problem that occurs with the abundance of data is because of the complexity of managing it and making it useful. An informed voter base is one of the strongest deterrents to political polarization. The solution created by the invented platform enables the voters in any election to be understood with greater detail and context providing a more detailed voter profile, which also includes voter sentiment and the identification of a voter's key issues, thus allowing a candidate to connect with voters in a more direct and tailored approach.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating a basic model for the utilization of device code for use in Artifical Intelligence driven programmatic digital transformation platform, according to one embodiment.

FIG. 2 is a block diagram that illustrates a suite of customizable applications in a Artifical Intelligence driven programmatic digital transformation platform, according to one embodiment.

FIG. 3 is a block diagram illustrating voter communication, according to one embodiment.

FIG. 4 is a block diagram illustrating filtering of content, according to one embodiment.

FIG. 5 is a block diagram illustrating media and content processed by a machine learning system, according to one embodiment.

FIG. 6 is a block diagram illustrating flow of data through various components in the Artifical Intelligence driven programmatic digital transformation platform, according to an embodiment.

FIG. 7 is a flow diagram of the exemplary processing of targeted content delivery, according to one embodiment.

FIG. 8 is a block diagram of data sources in Artifical Intelligence driven programmatic digital transformation platform, according to one embodiment.

FIG. 9 is a block diagram illustrating de-identified devices in the Artifical Intelligence driven programmatic digital transformation platform, according to one embodiment.

FIG. 10 is a high level flow diagram of the overall functionality of trageted communication, according to one embodiment.

FIG. 11 is a sample screenshot that may be used by an advertiser, according to an embodiment.

FIG. 12 shows an exemplary map of de-identified voters based on a specific criteria, according to an embodiment.

FIG. 13 shows an exemplary map of de-identified voters based on demographic data, according to one embodiment.

FIG. 14 shows an exemplary map de-identified voters based on demographic data, according to one embodiment.

FIG. 15 shows an exemplary map de-identified voters based on demographic data, according to one embodiment.

FIG. 16 shows an exemplary map de-identified voters based on demographic data, according to one embodiment.

FIG. 17 shows an exemplary map de-identified voters based on demographic data, according to one embodiment.

FIG. 18A and FIG. 18B shows exemplary user interfaces displaying the news website, according to one embodiment.

FIG. 19 illustrates an example machine of a computer system, according to one embodiment.

Although the specific features of the present invention are shown in some drawings and not in others. This is done for convenience only as each feature may be combined with any or all of the other features in accordance with the present invention.

### DETAILED DESCRIPTION OF THE INVENTION

Illustrated is an Artifical Intelligence driven programmatic Digital Transformation Platform (Also referred to as IQM platform in an exemplary embodiment herein) that is comprised of a suite of applications that have been designed for the use in politics for comprehensive targeted communications strategies and detailed analytics. The IQM platform is referred to as apparatus array because it consists of more than a single machine, interconnected to deal with higher complexity problems which may not be solvable on a single machine otherwise. Individual machine, may be regular central processing unit (CPU) or Graphics processing unit (GPU) driven machine or quantum computing based machine.

The IQM platform enables users of the system to more accurately measure voter enthusiasm, open mindedness, and political motivations. The IQM platform provides predictive models that indicate how, when and where voters consume media and advertising messages and can also include voter sentiment and the strength of voters' conviction around specific salient topics and positions that they take on all relevant issues. The predictive models can be placed within proforma data sets that are both created and displayed within media of any type. This data derived from any third party or organic source gives campaign managers and organizations deeper insights into the communities and help politicians develop policy initiatives more aligned with their constituents' values and beliefs.

The IQM platform enables organized campaigns, political action committees, political organizations, political parties and enables the government to access information about any constituent population. The resulting data provides contextual and behavioural targeting tactics that allow any political message to be tailored to the community where it is delivered. The invention enables applied political science analytics to inform media messaging a delivery strategy and has been developed to create the best and lasting impression on any voter. It monitors, for its users, specific voters for change in sentiment and also prioritizes and ranks the issues that are important within any electorate community. Conversely, the system can be used by a single voter or family of voters to determine which communities are best suited for their views or more in line with the philosophy or stance on any issue important to the person, family or group.

In one embodiment of the invention, the platform provides the technological ability to identify and communicate with voters who are undecided or outliers within the population of voters. Through the use of the invention's utilization of augmented and artificial intelligence (AI) driven (Including but not limited to, an Artificial General Intelligence with self-reasoning capabilities) political science data and other data sources is designed a process whereby the political constituents can be communicated to, via a targeted and message-controlled format that includes sensitivity and adjustability to political parties, politicians, political measures, legislative issues, judicial issues, campaigns or causes. The invention creates the capability to develop the use of artificial and augmented intelligence that leverages deep machine learning capabilities that allow for proforma and predictive political models. Various machine learning algorithms such as clustering, similarity search, classification, regression, and reinforcement learning algorithms may be used.

The embodiments direct to a ‘Political Intelligence Solution’ that automates the process of merging voter profiles, online data, offline events, public opinion, trends, and other data sources into a single, easy to use platform that guides users through the utilities and use cases. The platform-based tools are utilized to develop high functioning proforma models that leverage predictive analytics and political science models controlled both at the platform level and customized for use cases including overseas, International polling, voting and other related systems and deployments. The system looks at voter and consumer media intake and consumption patterns and it provides a geographical and political science data sets to it. The system then develops media and data responses from the systems that it provides and the use of voter sentiment or the other general voter behaviour and all other available data within the platform. Various embodiments described below may be used as web-based implementations. Targeted communication is not limited to signage, media, print, publication, press release, and other tradition and older digital systems such as email. That should not be limited in its scope of its usefulness by confining its novelty strictly to an online environment or strictly for the purposes of political campaigns and customized targeted content serving.

The use of proforma data helps project environmental conditions, simulations such as voter turnout and ambient conditions such as weather and 3D, 4D and evolving augmented and virtual realities. Voting conditions are simulated and displayed both in actual and proforma simultaneously in integrated or isolated environment; the data can be experienced and sensed through all artificial reality systems. The variable conditions such as weather, stock market performance, farming conditions, legislative, legal, and media, etc., may be set as conditions and a resulting proforma can be generated dynamically to be based on the conditions set. In an embodiment of the invention, weather can be simulated, and a candidate can inspect likely and projected polling place, turn out and modify the signage, personnel, get out the vote initiatives and resources accordingly.

Data indicators such as early ballot receipts, postal activity, delivery, logistics, technology, security and other aspects of voting systems are monitored through data sources and the invention assimilates them through IQM platform and the supporting software for their display. Data accessed by systems are available for the augmented and artificial intelligence systems to assimilate and perfect the proforma. The configuration is not limited to candidates and may include causes and ballot initiatives presented in any vote. Further, the proforma, such as rain, traffic delays, polling location problems or other factors on an election day, can factor in to create improved and layered conditional performance and then display.

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

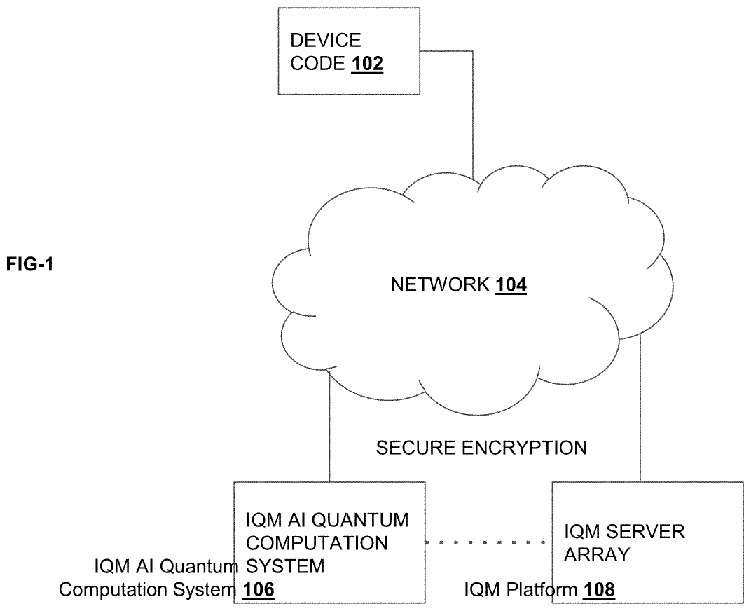

The various embodiments disclose a system and method for geographic political science targeted communications and data platform. The platform and associated functionality of the present disclosure (also referred to as “IQM”, the “IQM system”, or the “platform”) is configured to target content, media and advertisements to an online audience that is understood through applied political scientific data. The data is processed through artificial and augmented intelligence that is stratified and made available for users utilizing a ubiquitous framework and delivery format. The IQM platform is also informative and enabling any electorate constituent population to be better understood. The ability to manage, display and develop content around these assets is paramount to last minute decisions prior to the deployment of final campaign pushes and voter initiatives for all parties and all viewpoints. These types of tailored communications are enabled by this technological improvement, wherein the platform creates a data and communications strategy tailored and targeted for each use case in which the platform is initiated. In one embodiment. FIG. 1 is a block diagram illustrating a basic model for the utilization of device code for use in IQM platform, according to one embodiment. The device code 102 is a unique identifier associated with a device. The IQM platform collects data from content demands (such as ad requests, integrated tracking system or acquired from partners) as well as when user views content on the device pushed by the platform. Each device has unique identifier, and the platform collects data and generates data along with demand request or manually registered on the platform via any system.

The device code 102 is transmitted through a secure encryption network 104 to the IQM AI Quantum and non quantum computation system 106 and the IQM platform 108. The IQM AI Quantum and non-quantum computation system 106 uses the device code 102 for further processing. In one embodiment, the AI Quantum and non-quantum computation system consists of quantum and non-quantum computers. The IQM platform 108 derives the data it utilizes from information commonly collected in standard web analytics and used for ad-serving, which includes common information found in every form of web communication sent over the Internet to traditional signage and mailing campaigns. Further advanced systems such as behavioural targeted data, deep web, and analytics combined with the messaging across a multitude of delivery and execution mechanisms that are central to the present disclosure's utility when used by political campaigns and other comparable user groups. These types of data sources allow the IQM platform 108 to perform functions called upon by users and automatically invoked for their use based on timed events, analytics timing windows, and configurable time lines. The times events include voting day, Scheduled rally, Scheduled conventions, Meet-ups and gatherings, etc., events, it also covers holidays as events, festival days, etc. Some examples of analytics timings windows include analysing data during weekends, at particular range of hours in a day, range of days in a month, or year. Timing window in co-relation with the timed events that would be the analytics timing window in user configured timelines.

The platform will upon delivery of content, utilize infrastructure that will infer such things as browser type, operating system, browser language, Internet Protocol (IP) address among other things; Internet Service Provider, and mobile advertising identifier, for mobile devices such as smartphones and tablets.

The IQM platform 108 is also used to collect data regarding voter profile interactions, including their use of other websites and mobile applications, advertisements, and other pages on the Internet accessed by the voter. The IQM platform 108 may also receive Precise Location Data generated from use of mobile devices, such as the latitude/longitude coordinates provided by the mobile application publisher or other media supply source in conjunction with Real-Time Bidding (RTB) and Targeting Platforms for the opportunity to purchase advertising inventory. The data and media exchange that form the data sources in multimedia including video and audio are within in the scope of the present disclosure and enable both the predictive and other targeting and management reporting systems within the IQM platform 108.

The IQM platform 108 utilizes “cookies,” mobile advertising identifiers, and other technologies to enhance users' experiences on the web, to deliver more relevant ads. Though cookies are useful, the present invention is not tied to any single method for the delivery of code delivered from the platform to interface with devices and end users ubiquitously. Other systems, including those embedded in code using Java code and Java scripts as well as messaging via SMS and email, are all contemplated, and it includes various consumer engagement processes including but not limited to the use of bar codes, inaudible tones, RFID, signage, mailers, print materials, buttons and wearables, books and publications. To maximize the compatibility and use, the IQM platform 108 also utilizes device IDs, device software driven content and device matching tools to help determine with a high probability of likelihood that a device is associated with an end user through the identification and matching of various Device IDs at the various locations and devices that each unique end user may use to log into the internet. This cross-device targeted advertising is utilized to deliver highly relevant content and advertising across multiple devices, while identifying or differentiating various end users on the system. These technologies can be utilized to help recognize a computer or device to deliver relevant advertising to voters and measure the impact of that advertising to help identify, recognize and analyze digital media usage patterns and the political science data.

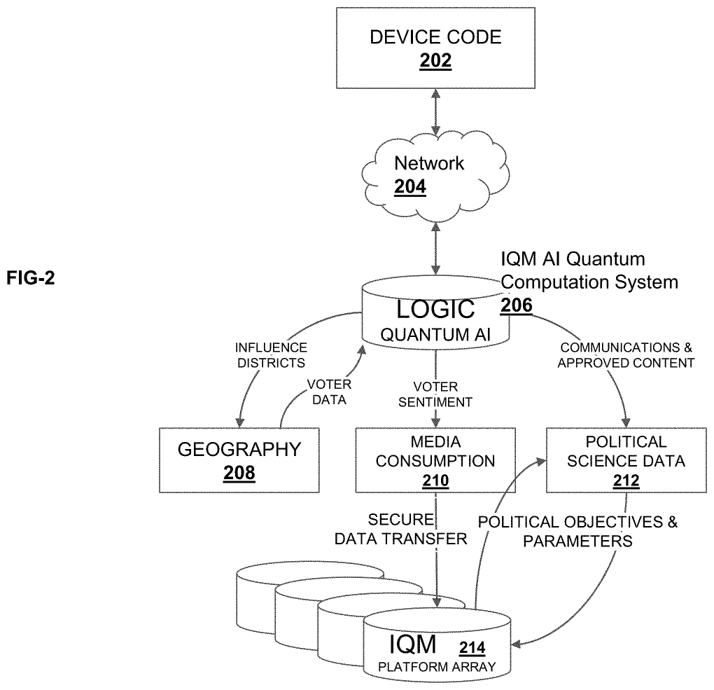

FIG. 2 is a block diagram that illustrates a suite of customizable applications in a IQM platform, according to one embodiment. The data collected from a device along with device code 202 is sent over a secured network 204 to IQM AI Quantum and non quantum computation system 206. The customizable applications include geography 208, media consumption 210 and political science data 212. The customizable applications are used in identifying and assessing various consumer or voter interactions with targeted content and communications. The IQM platform 214 provides for the command interface and is fully upgradeable and positioned adjunctive to any ad, data, content delivery, or voting mechanism.

An embodiment of the present disclosure utilizes Artificial Intelligence and a Machine Learning interface in the IQM AI Quantum and non quantum computation system 206 to create voter matching tools which are used to establish a variety of models for measuring and quantifying varied degrees of voter profile-based scoring elements. These profile elements are used to measure the potential to influence each voter's mindset through platform-based interactions within each voter profile element contained in the IQM platform 214. The influence rating for consumer and voter mindset scoring in the IQM platform 214 is defined and weighted by each user profile tracked consumption of digital news and information related to a candidate or campaign. In an example of voter mindset analysis determination, platform considers realtime and historical media consumption and user activity analysis with user's consent, examine these details including content user read or interacted or consumed periodically over the period of hours, days, weeks and months to determine the mindset analysis. For influence rating of the influencer, it depends on how the influencer is relevance for influence. System determines a rating for each influencer based on relevance, relevance depends on what message/current-affair topics/views and feedbacks/generated suggestive outputs/opinions in any form/trends the influencer follows or generates output for. Influencer can be a user of any social platform, media platform, content publishers, entity, organisation, specific-geo place/country, a political candidate, a person, a technology or data driven outputs.

The ability to measure and quantify voter mindset based on media consumption 210 empowers campaign managers to make more informed decisions on messaging and frequency; including what, where and when to publish a candidate's digital content, allowing campaign managers to refine and customize the focus of each political message to present a more compelling and on-point message that can be fully customized to cater to the key topics, voter concerns and values for each member in the digital audience.

In an embodiment, the IQM platform 214 utilizes predictive voter models and pro forma data to determine, analyze and segment profile data to indicate various user-based consumption of media into groups of unique, separate and measurable scoring attributes. The first scoring attribute looks at the general slant or viewpoint of each user's media consumption 210 and if that media has either a general positive or negative viewpoint on a candidate or issue. As a second profile scoring attribute, the platform systems measure the voter consumption of media and when consumed which destination media site was accessed and how long the specific engagements last and finally, were there any consumer interactions such as forwarding or other activities tied to the content being consumed.

The attributes are weighted and segmented based on predetermination factoring in whether the media consumption 210 is from sources and sites more grounded in fact or sensationalism. The IQM platform 214 can weight if a voter's media consumption 210 of media is from a verified and trusted news source or if the voter's consumption of media is focused on sites that trend toward sensationalism or are generally understood to identify with a right or left leaning source. The platform then processes the data from the various scoring attributes into a confidence score that is used to measure and quantifies the accuracy of the profile data.

The data received from the device code 202 is then processed through two levels of machine-learning. The first machine-learning layer utilizes data from various data partners. The second machine-learning layer utilizes a proprietary layer of data tools and data structures to formulate a measurable range that is tabulated on a scale determined by applied political science data 212. The IQM platform 214 then applies a confidence score for any issue or position that a voter profile is associated with, and one that measures for the accuracy of all the findings based on the data provided by the campaigns, plus two layers of machine-learning. The first machine-learning layer comes from various data partners, and then via a proprietary machine-learning layer of algorithms that produce a confidence score rating. The system and apparatus array are in a state of readiness and upon incoming data request an orchestration of data is achieved through the IQM platform 214. The information is transformed and formatted into usable reporting, analytical and content data. In another embodiment, a system of the present invention utilizes profile data elements for its ‘voter matching’ tools and multiple conditional settings that can be adjusted in the proforma analysis of data and upon the review and parsing of real-time captured data.

The voter and consumer media intake and consumption patterns are collected and analyzed using the geography 208 and the political science data 212 along with the media consumption 210. The IQM platform 214 can generate various unique voter profile data points specifically to inform, assemble and execute campaign communications that are tailored to users' known choices, media habits, beliefs, biases, subject specific sentiment and messaging preferences. The profile of unique voter characteristics and the platforms targeting software enable the production of content, data driven reports, media assets and other targetable insights from the voter profile are created.

The platform processes large sets of proprietary algorithms that provide voter characteristic matching and advertising insights based each users' media consumption and general content preferences. Through the use of machine learning and cognitive artificial intelligence the IQM platform 214 is able to create predictive models and insights regarding the potential impact of communications executed by a campaign. The specific political science data 212 generated is unique in that voters are identified along with a comprehensive political profile that improves the ability for a campaign to understand their constituents, what matters to them and what they will and will not vote for and for whom they are most likely to cast a vote in favor or opposition of The IQM platform 214 based insights into voter behavior provide the added ability to target an end user based on the historical media consumption data for each online user and provides the ability to update user targeting parameters based on voter and end users ongoing consumed daily media content, combined with targeted user and content analysis parameters, which are used to determine the optimal type of content to target to each specific voter.

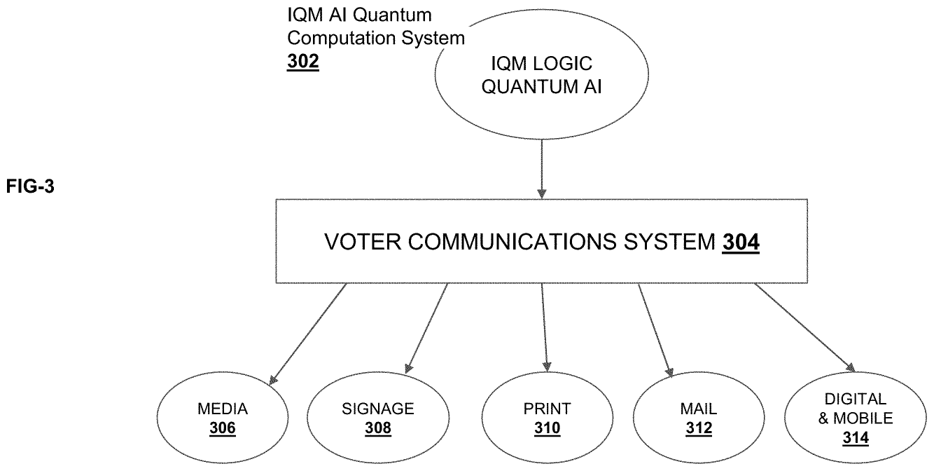

FIG. 3 is a block diagram illustrating voter communication, according to one embodiment. The IQM AI Quantum and non-quantum computation system 302 processes the request received from a user device to de-identified user media consumption and retrieve the content from the request. De-identification is the process used to prevent a user's personal identity from being revealed. Platform creates a single usable de-identifiable key (can not be reverse engineered) in realtime which helps further to determines the relevant segment of the user device and relevant content to be pushed. For example, data retrieved from the user device is de-identified to preserve privacy of the user. The voter communication system 304 is targeted to provide approved media 306, signage 308, print 310, mail 312 as well as online digital content that is formatted for mobile communications devices 314.

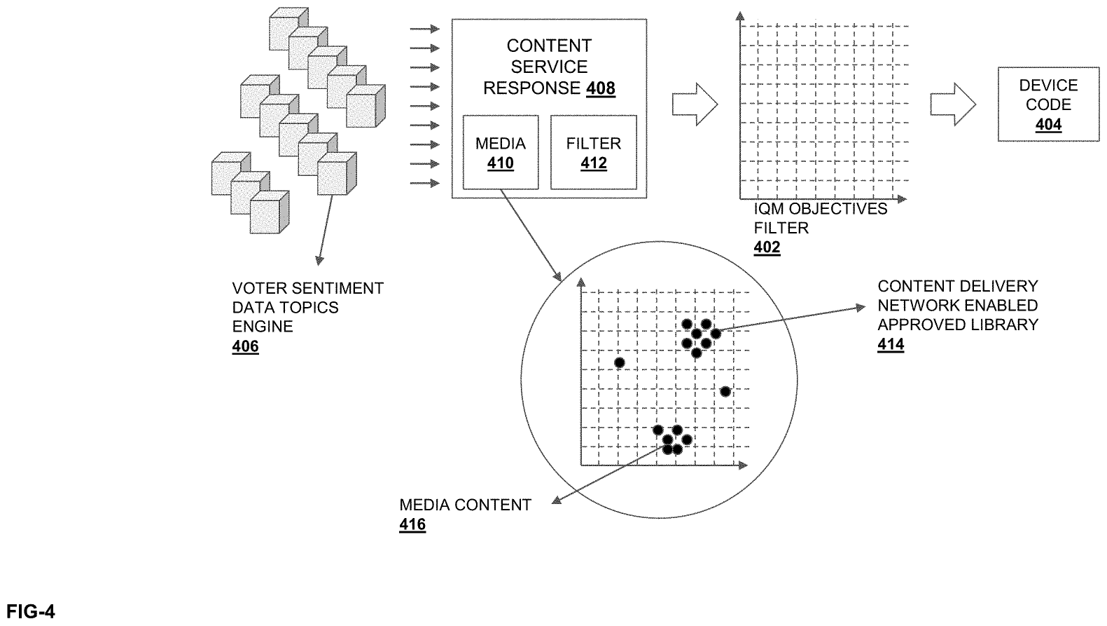

FIG. 4 is a block diagram illustrating filtering of content, according to one embodiment. The political science data used for geographic targeting of electronic content provided by the IQM platform enables filtering the data for targeted communication to device. The IQM objectives filter 402 provides intelligence and further targeting, filtering and formatting content that is sent to the device associated with a device code 404. The objective filter is a software filter driven by AI behind the scene. We use similarity-search engine to find the most suitable content to push to the request, objectives filter 402 is a custom developed AI software driven by custom search engine to determine relevant content for the demand.

The voter sentiment data topics engine 406 is used to provide the data as the content service response 408 that includes media 410 and filter 412. The media 410 uses a content delivery network enabled approved library 414 to generate media content 416. The generated media content 416 is embedded in the content service response 408. The IQM objectives filter 402 provides targeted communication to the device.

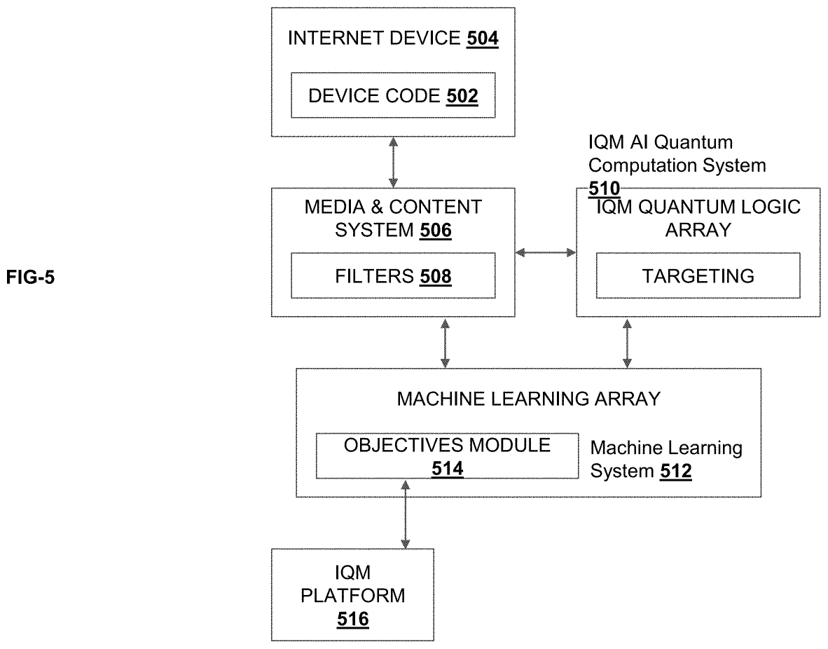

FIG. 5 is a block diagram illustrating media and content processed by a machine learning system, according to one embodiment. A user's device is associated with a device code 502 where the device is connected to internet and the user accesses information available in the internet via web pages. Hence the user's device is referred to as the internet device 504. The media and content accessed by the device code 502 is sent via an encrypted network to the media and content system 506. The media and content system 506 includes filters 508 to filter the media and content before rendering it back to the internet device 504. The gathered media and content information is sent to the IQM AI Quantum and non-quantum computation system 510 for processing. AI analytics is performed on the gathered media and content information to generate targeted communication to the internet device 504. The media and content system 506 and the IQM AI Quantum and non-quantum computation system 510 is connected to the machine learning system 512. The machine learning system 512 includes an objective module 514 responsible to identify relevance for demand, content and targeting such as geo graphical segments like zip code, city, district, state, etc. This module also includes other segments (but not limited to) like Technology, Demographics, Behaviors, Interests, Media consumption, sentiments, Political-Issues, etc. The data from the machine learning system 512 is sent to the IQM platform 516 for further processing. The IQM AI Quantum and non-quantum computation system 510 and the machine learning system 512 are used to establish a variety of models for measuring and quantifying varied degrees of voter profile-based scoring elements.

The first scoring attribute looks at the general slant or viewpoint of each user's consumption of media and if that media has either a general positive or negative viewpoint on a candidate or issue. As a second profile scoring attribute, the IQM platform 516 measures the voter consumption of media and when consumed which destination media site was accessed and how long the specific engagements last and finally, were there any consumer interactions such as forwarding or other activities tied to the content being consumed. Final scoring is determined by custom aggregation logic and custom algorithm which uses Objective module and determined relevance score for Media and Content, Targeting, media consumption. The final scoring determination formula is evolved by AI on a periodic basis.

The IQM platform 516 processes large sets of proprietary algorithms that provide voter characteristic matching and advertising insights based each users' media consumption and general content preferences. The IQM platform 516 provides the internet device 504 with targeted communication based on the users' known choices, media habits, beliefs, biases, subject specific sentiment and messaging preferences.

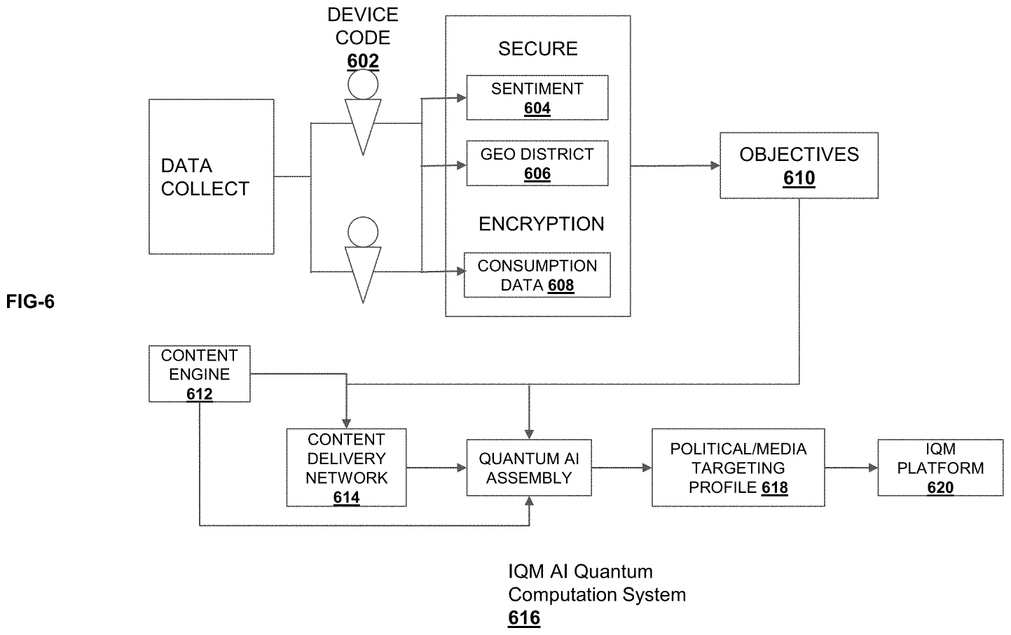

FIG. 6 is a block diagram illustrating flow of data through various components in the IQM platform, according to one embodiment. Data collection is performed at the devices where the devices are associated with respective device code 602. The collected data includes secure sentiment 604, geographic 606 and consumption data 608 and the data collection that occurs with the use of the device code 602. The collected data is sent to the objectives module 610. The objectives module 610 includes sentiment module, Geographic module, Media Consumption module, Political Issue, etc. Generate multi dimensional time series based data aggregation for metrics.

The content engine 612 enables processing the collected data using the content delivery network 614, IQM AI quantum and non-quantum computation system 616, political media targeting profile 618 and the IQM platform 620. Various types of data is received at the platform from multiple sources. Platform generates segments and dimensions such as Geography, interests, demographics and stored in the objective module. The content engine gets segmented and is mapped to the objectives module. Simultaneously contents are pushed to content delivery network 614 and the objectives are passed to the IQM AI quantum and non-quantum computation system 616. Further, the IQM Al quantum and non-quantum computation system 616 scores the political media content.

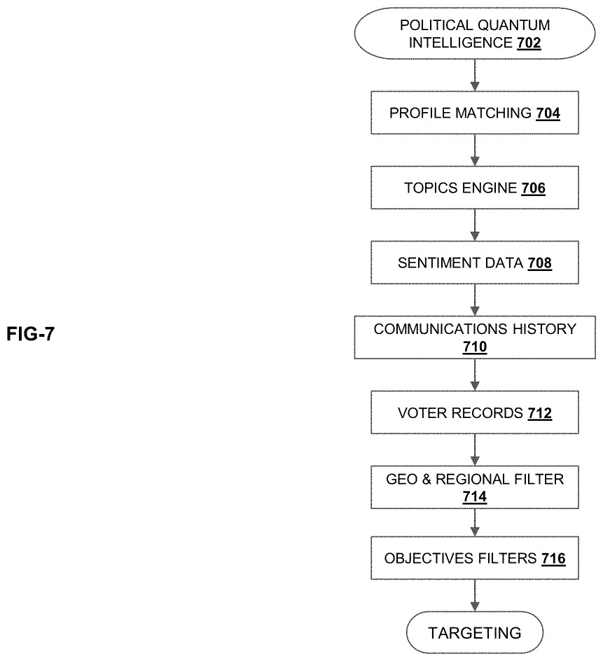

FIG. 7 is a flow diagram of the exemplary processing of targeted content delivery, according to one embodiment. The data collected from the user device is processed through a series of systems/components until a targeted message is generated. At 702, the political science database is used to apply political science analytics to generate media messaging a delivery strategy to create the best and lasting impression on any voter. At 704, the profile matching on the collected data regarding voter profile interactions, including their use of websites and mobile applications. The Internet Voter Profile creation is utilized to provide voter specific audience matching and content and article consumption determinations across multiple voter demographic based data points. At 706, the topics of interest are extracted from the collected data. At 708, the sentiment data is used to monitors, for its users, for change in sentiment and also prioritizes and ranks the issues that are important within any electorate community. At 710, communications history of the user is analysed to understand the behaviour and pattern of the user. At 712, the voter records that are maintained are analysed to match the specific user to apply the various analysis. At 714, geographic and regional filters are applied on the data to generate specific targeted communication to the end user. At 716, the objectives module ensures that processing of the data is aligned with the objective with which the IQM platform was used and the targeted communication was generated accordingly.

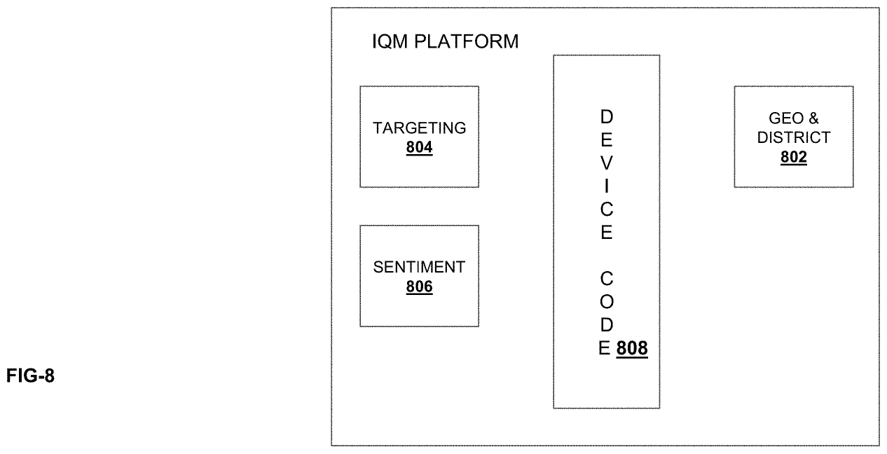

FIG. 8 is an exemplary data sources in IQM platform, according to one embodiment. The various data sources such as geo and district 802, targeting 804 and sentiment 806 with reference to the device code 808.

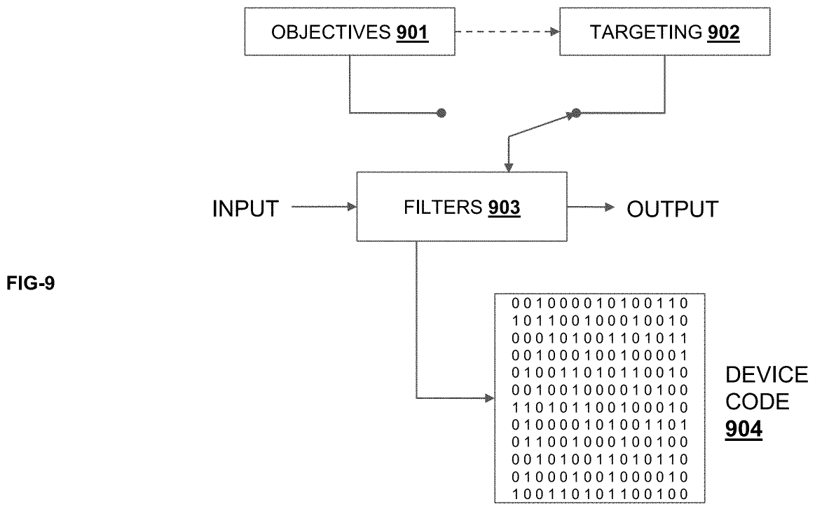

FIG. 9 is a block diagram illustrating de-identified devices in the IQM platform, according to one embodiment. Based on the objectives targeted filtering is performed and the filtered media content is provided to the user device. The objectives module 901 includes Content, segments, Political issues, etc. It also includes targeting segments. The targeting module 902 includes Geographical places, Interests, demographics, Technology users etc. The filters 903 is responsible for generating relevant data according to data inputs such as content demands, tracking system events. The relevant data output determines the content to be pushed or relevant input for the demand generated by system. The device code 904 is an input for the system to generate de-identifiable key which would be similar /relevant to the de-identifiable key which was generated previously by the same/similar device code.

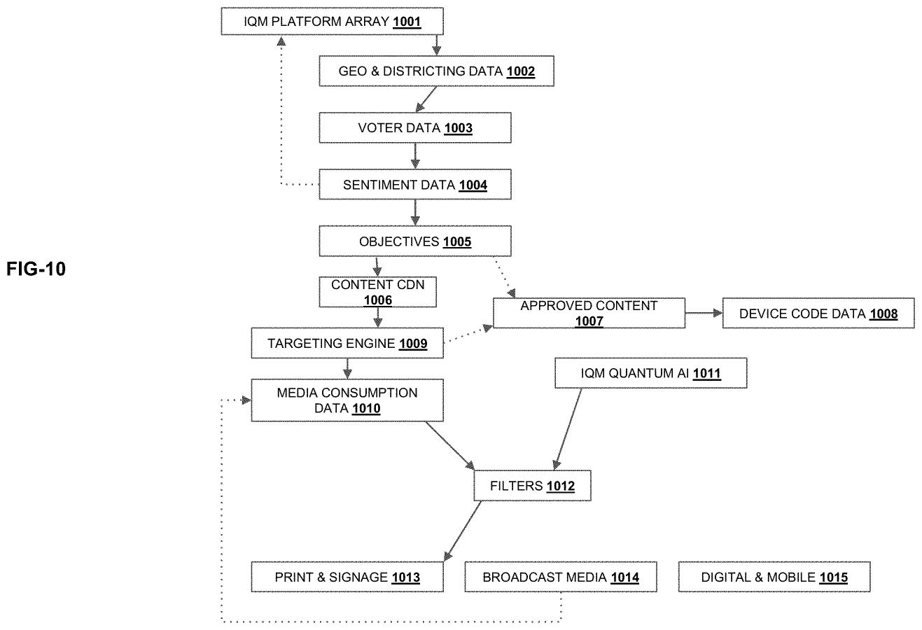

FIG. 10 is high level flow diagram of the overall functionality of targeted communication, according to one embodiment. The IQM platform includes IQM command software with the ability to control performance (accelerate/decelerate) multi-dimensional segment to improve relevant content delivery with user interface for targeting devices for the content delivery. The predictive models performed by data ingress from the IQM Command software is used to measure the media consumption, voter enthusiasm, voter sentiment, voter decision-making creating a system hierarchy for stratification and conviction level of a voter's primary political drivers and concerns when placed within proforma data sets for targeting content within an online targeted content system. Combination of Geo & districting Data 1002, Voter Data 1003, Sentiment Data 1004 generates/collects data from multiple sources (as mentioned in FIG. 8) powered by IQM Platform array 1001. Starting from collecting data from source, platform determines geographical segments 1002 of content demand after generating de-identifiable key, further it starts matching with voter profiles 1003 segments and sentimental segments 1004. All these segments becomes Objectives for Objective Modules 1005. The Objective Module 1005 generates matching content relevant to demands and push it to content CDN 1006. Objectives 1005 can be passed through approval flow 1007 which further creates/updates set of device segments accordingly for targeting 1009 and delivery decisions. Each targeting decisions will be recorded as media consumptions 1010 which will be further used as Objectives 1005. The filters 1012 is a custom developed AI software driven by custom search engine to determine relevant content for the demand, it also considers Media consumption 1010. Filters 1012 works based on IQM Quantum AI module 1011. IQM Quantum AI module 1011 is a multi array module which takes system level decisions like Key generation to accelerate/decelerate etc. The broadcast media 1014 is referred as media sites, publishers and any content-publishing outlets. The digital & Mobile 1015 is content displaying machines/devices which displays pushed contents by the platform.

The IQM platform also provides the ability to target an end user based on a single or combined group of content targeting indicators including, Media Consumption Analysis determined as follows. How: Specific to device type and mode of media consumption When: Time and date of media consumption, Where: Geolocation of media consumption, What: Type of media consumed and general political lean of sites and articles, Which: Frequency and trend toward a specific political preference or affiliation in media consumption. The ability to track and measure a user's media consumption provides the ability to target segmented groups of voters based on any combination of these sentiment and behavior-based parameters and provides the ability to customize and optimize each type of advertisement or content targeted to each end user or voter segment.

The platforms' machine learning analysis utilizes Natural Language Processing to analyze the page content in conjunction with each available voter profile indication of media consumption and each known voter profile data points indicators to optimize each item of content or ad served to the user. The NLP process analyzes the page for decency, content political skew, content bias, content tone, content point and counter point and can be adjusted to accommodate other content analysis elements. NLP AI model includes quite a few techniques specific to Natural Language understanding tasks to be performed by machine. Using this techniques, the IQM platform 1001 is able to assign scores for decency, content political skew, content bias, etc. attributes.

The initial process for Voter Profile creation is utilized to provide voter specific audience matching, content and article consumption determinations across multiple voter demographic based data points. These data points are integrated with RTB exchanges which send the ad requests to the platform, which analyzes the user identification information from the ad request to make various ad determinations based on each data element related to voter article consumption.

Another example explained below is the Audience Matching (based on sentiment for issues) where (a) Voter profiles are initiated within the IQM platform by identifying a single or multiple device for a particular voter, which is utilized to provide user specific Audience Matching for each matched voter device and (b) The IQM platform stores the proprietary user specific third-party datasets in proprietary Primary Keys indicated as (D1, D2, D3) within the platform. Primary key is used to identify segment mapping to targeting parameters and objectives. It has nothing to do with the User or Voter data. Users of command software provides raw voter data to initiate audience matching.

The Platform utilizes these proprietary Primary Keys for each available distinct dataset along with data related to the type of information that is carried in the datasets. The Primary Key datasets are as follows:
a. D1 [Key: device ID]—demographic information (constituent voter information)
b. D2 [Key: Voter ID]—demographic information, Personally Identifiable (P1) information, party affiliation, household voting data per individual
c. D3 [Key: Voter ID]—political alignment, political sentiments, media consumption, political science data, surveys The Primary Key datasets are determined and categorized based on the available data sources. Device ID voter data is received from each Real Time Bidding (RTB) requests and stored in D1 [Key: devicelD]. Voter data is received from approved RTB requests and stored in D1 [Key: devicelD]. Voter profiles are created for storage of any available personal information (P1) information e.g. name, email, phone number, etc., (derived from tracked user data or from a third party and includes profile, demographic and PII such as voterID, device ID, IP, etc., and is stored in D2 [Key: VoterlD]). Multiple device IDs can be assigned to a single voter and can be determined based verified voter data or determined based on similar political sentiments and demographic information across shared devices, and stored in D1 [Key: device ID] or D3 [Key: VoterID]. In an embodiment, unique voter targeting insights and capabilities can be generated through singular or combined targeting and cross-referencing of any of the data between the D1, D2 and D3 datasets. The Platform assigns a Content Management System (CMS) to analyze each individual page and the page content and adjust the content of each advertisement served for Decency, Political Skew, Bias and Counter Argument through Natural Language Processing that analyzes the content of each page in combination with the NLP and the voter persona data to customize the ad served to the user. CMS is a part of IQM Platform where it stores individual page in correlation with Device and other segments for generating further classification such as factual, sensational stories, etc.

Two examples of content analysis by Device ID are explained below. Content Analysis (based on sentiment per candidate) is explained further. The IQM platform assigns each URL, a sentiment analytics API and generates a score between 0 and 1 for multiple political candidates. A user in the RTB request is uniquely identified via device ID information. Voter sentiment and behaviour are de-identified and tracked based on the device IDs for each candidate. Historic sentiment and behaviour are also tracked based on user specific historically visited URLs. The retrieval of scores within the sentiment analytics API. The campaign details and requirements are well identified beforehand, based on sentiment score ranges or devicelD. According to the campaign details and any other specific data requirements, when a new RTB request is received from a pre-identified device ID, the platform determines the best fit advertisement or content selection. As mentioned in Objective module details, Sentiment analytics API is a type of Objective. Score determination of segments mentioned above.

Content Analysis (based on sentiment per candidate in URL content) is explained as follows. Voter profile pertains to the general sentiment of each voter (identified by device ID) and measuring potential voter affinity for each particular candidate. Sentiment stored per Device ID's are updated for each new instance of a RTB request received for that ID and utilizes a similar process as indicated above to analyze page content and adjust the content of the advertisement based on voter profile parameters. The advertisement is customized for each device ID and is chosen based on the sentiment score for relevant candidate. Provided below is a third example that illustrates a key element of the invention that ties in various available data elements by cross referencing each of the Content Analysis and Audience matching data points related to voter sentiment and page, advertising content analysis.

Sentiment of Matched Audience is another exemplary use case explained below. The Voter profile in this example is utilized for identifying multiple device IDs for a particular voter, and tracked via user sentiment per candidate. For each voter the platform extracts Voter profile data from the Content Analysis (based on sentiment per candidate) and takes the average sentiment determination for each devicelD from the Content Analysis (based on sentiment per candidate in URL content) to calculate an overall voter sentiment determination and potential voter inclination toward each candidate. The customized advertisement is chosen based on identified voter data for each campaign utilizing personally identifiable voter data and a sentiment score for each relevant candidate. These case examples illustrate the use of a Machine Learning process that allows the platform to adjust ads and content over time based on confirmed changes to each voter profile.

Use Case 1: Audience Matching (based on P1 information and sentiment for related issues). Voter profile data is first defined by identifying multiple devices for a particular voter, which generates a platform-based Audience Matching determination for each single voter device match. The Voter profile is updated on a scheduled basis (or determined by the admin). The platform can purge old data as more current and reliable voter profile data is obtained . The determination of the time to live (TTL) related to the time length of voter data validity can be determined by the admin or based on the lifecycle of each campaign or candidate . The Voter profile is also updated, whenever there are changes or updates to any segment information at the D1, D2 and D3 data sources. The ads are selected for the RTB process are only selected when a relevant device ID is encountered in the RTB and only if the request the advertisement or content is relevant to the Voter ID based on the most recent Voter profile data contained in the system .

Use case 2: Content Analysis (based on sentiment per candidate in URL content. Voter profile data that is identified relates to the sentiment of each voter (identified by device ID) for a particular candidate. The sentiment per Device ID is automatically updated whenever a new RTB request is received for that ID allowing the CMS to Analyze URL page content and adjust the content of the advertisement for Decency/ Political Skew/Bias and Counter Argument etc.

Use case 3: Sentiment of Matched Audience (intersection of use case 1 and 2). Voter profile data is considered as identifying multiple device IDs for a particular voter and tracking the sentiment per candidate. This voter profile is updated whenever the segment information changes in D1, D2 and D3 data sources, or when a new RTB request is received for the device IDs identified in a particular voter profile. The platform utilizes demographic information to segment third-party datasets from D1, D2, D3 (in this example D1 is used as the primary key cookie ID). Methodology to identify end user utilizes a tracking cookie ID instead of deviceID. Methodology to de-identify end user utilizes a tracking cookie ID instead of device ID. Profile updates will result in de-identification of some cookieIDs. Information is accessed from third party software systems including operating systems, browser and mobile data sets and that data can be used to create voter profiles that are further enhanced with greater specific detail. The consumption of new content by the profiled user continues to be appended and updated as the content is read, watched, heard by the user. The de-identification and re-identification of the end user allows for the system to assign a value to the users' most recent media consumption activities and it can prioritize to search and focus on specific content subjects. In one embodiment, recently consumed content by the user, is compared to the previous content and insights and inferences can be derived as a result. The voter profile creation and updating methodology for each user facilitates the ongoing modifications to profiles in real-time. The platform consumes data from third-party data sources of any source. It also has a functionality around the ability to de-identify data within the system, which is accomplished by hashing personal data sets.

In Detection of fraud RTB requests, the platform utilizes a deep learning-based model to detect one of many types of fraud in the RTB requests, i.e. domain spoofing. The platform provides PoC done for detecting fraud URL sites, majorly created to attract advertisers and earn money, with no ROI for the advertiser . The training data used for this PoC is collected from public sources and is outdated the platform will outsource a reliable tagged data, in order to utilize this methodology in our architecture . As per the Open RTB Standard the platform is integrated with exchanges which provide requests from consumer (end user) through publishers, SSPs and then by Exchanges to us as a DSP. SSPs are Supply side platforms or Ad Networks which are integrated with publishers to auction ad spot supply, exchanges is where the auctions of the ads spots are happening in real time environment, DSPs are the systems which bids and serves ads in real-time. These requests include basic information about the end-user device (such as Device ID, device location, type/model etc). This is the end-user/voter device ID. Voter profiles are generated by this methodology. The device ID are received in the RTB requests, and we match to the end user based on already generated voter profiles.

The following are some of the significant elements coming through RTB. These are user consented data compliance with concurrent laws of the land. 1) Imp: Impression Related details, also represents the impressions offered a. Banner: If ad demand is for Banner (Display) more details like creative size, media type allowed (MIME), etc. b. Video: If ad demand if for Video, more details about it like placement of ad in video (before—pre-roll, after—post-roll, in between—mid-roll), durations. 2) App: If ad is originated from an App, more details about it goes inside this. a. Publisher: Publisher Details of specific App. b. Cat: IAB Category of given app. 3) Site: If ad is originated from a Site, more details about it goes inside this. a. Publisher: Publisher Details of specific Site. b. Cat: IAB Category of given site. 4) Device: The device details from which the ad is originated. e.g. Device location, User Agent, Carrier, Unique Identifiers, Screen Size, etc. 5) Beat: Blocked Categories for given Ad Request (Demand should not send ad creative of this IAB Category) 6) Badv: Blocked Advertiser Domain for given Ad Request (Demand should not send ad creative if it falls in given list of Blocked Domains).

Voter data comes directly from customers of the platform and from reputable data partners that adhere to strict privacy standards. The media buying application does the heavy lifting as technology helps define a core base and target undecided voters. The innovation allows campaigns and constituents to connect with their voter base more efficiently and motivates people who are undecided to vote in your favour. The application allows users to control their campaign budget while automating the targeting, purchasing, and reporting in one interaction. The IQM platform provides a political media purchasing application that provides all of the tools and insights needed to reach voter demographics. Gain a better understanding of voter behaviour over time and their motivations to make strategic decisions, inform messaging, and drive engagement. The Voter Intelligence module enables clients to serve as a cognitive agent of voter intelligence data. In addition to segmenting and visualizing real-time voter data, each application provides the ability to automate insights on rally and event-based voter intelligence. Location-based, event-driven queries are supported by historical and real-time data, combining a First Party Data matching ability with a voter's device ID graph. The Voter Intelligence application provides a single place to seamlessly search and visualize audience segments in an easy-to-access, scalable environment.

In Segmentation and Exchange, Data as a Service (DaaS) is the fuel for organizations to enhance voter experiences, build campaign awareness, and better understand demographic targets. The platform provides data segmentation expertise and deployable solutions for consumer data in real time. The platform can seamlessly onboard 1st, 2nd and 3rd Party data partners providing a DaaS platform with a scalable solution for all partners in the exchange. For data partners are provided the opportunity to segment and monetize 1st Party consumer data while providing full transparency of cost, usage and revenue, while providing multiple data security management and real-time data consumption cost and margin management. The scalable DMP is available to data partners at no charge, providing an easy-access, deployable platform. DMP (Data Management Platform) is able to handle any type of data, match it deterministically or probabilistically for the purpose of personalized and relevant content delivery.

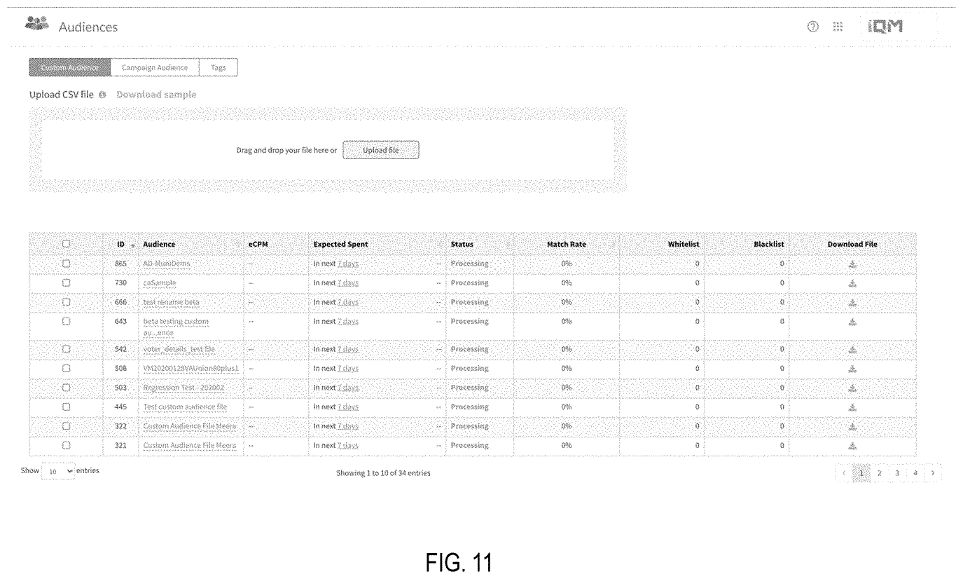

FIG. 11 is a sample screenshot that may be used by an advertiser, according to one embodiment. The advertiser may use the national voter record file to select and target groups of voters.

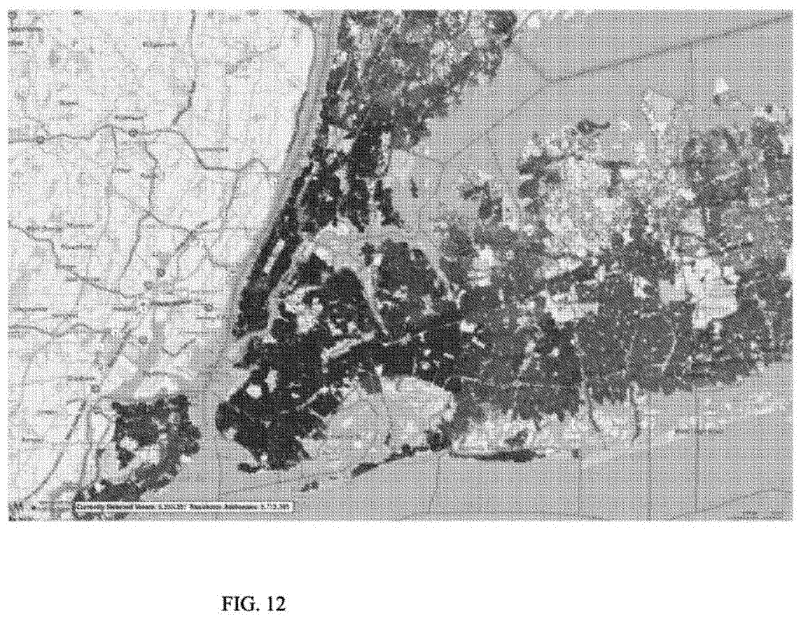

FIG. 12 shows an exemplary map of de-identified voters based on a specific criteria, according to one embodiment. The exemplary map shows the voters alignment to specific political parties in a graphical representation for example, for the city of New York showing Democratic in blue (lighter shade) and Republican in Red (darker shade). These graphical representation provide a sense of voter sentiment across a specific geography.

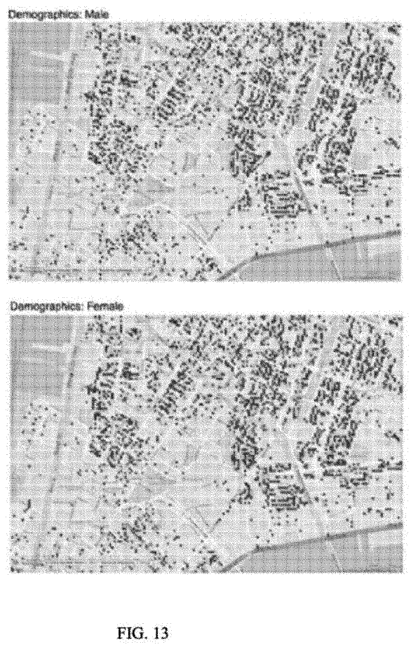

FIG. 13 shows an exemplary map of de-identified voters based on demographic data, according to one embodiment. This map shows the de-identified voter list representing the male population and the female population respectively.

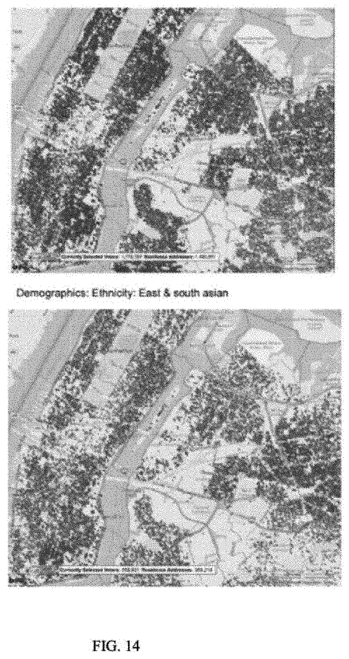

FIG. 14 shows an exemplary map de-identified voters based on demographic data, according to one embodiment. This map shows the demographics based on ethnicity, for example, East and South Asian.

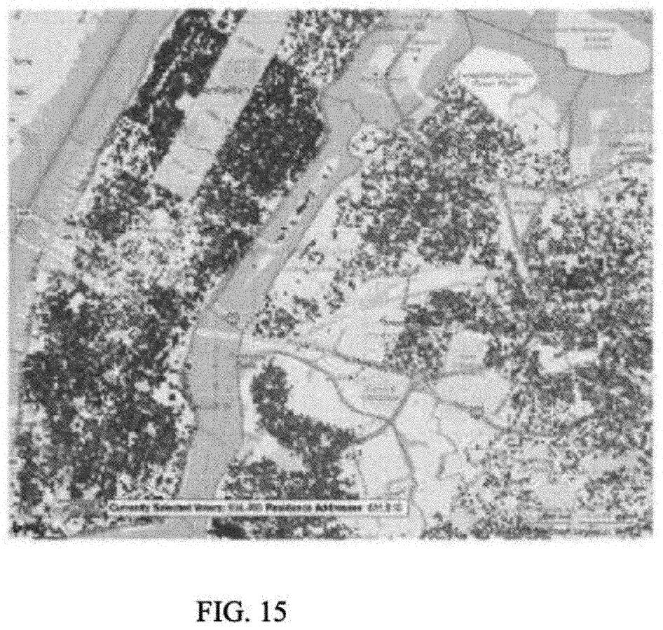

FIG. 15 shows an exemplary map de-identified voters based on demographic data, according to one embodiment. This map shows the demographics based on religious belief of the voters, for example, Buddhist and Jewish.

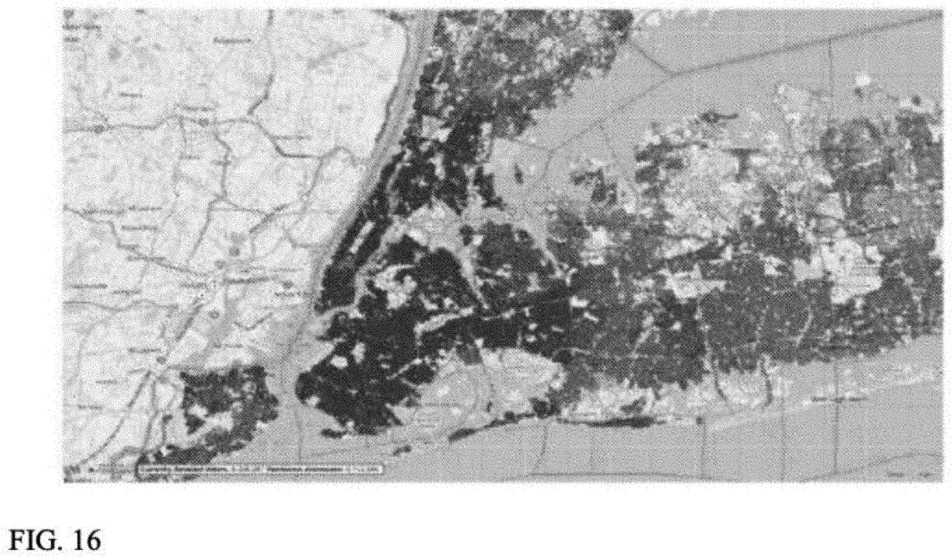

FIG. 16 shows an exemplary map de-identified voters based on demographic data, according to one embodiment. This map shows the demographics based on the party that voters support, for example, the map shows supporters of a specific political party X.

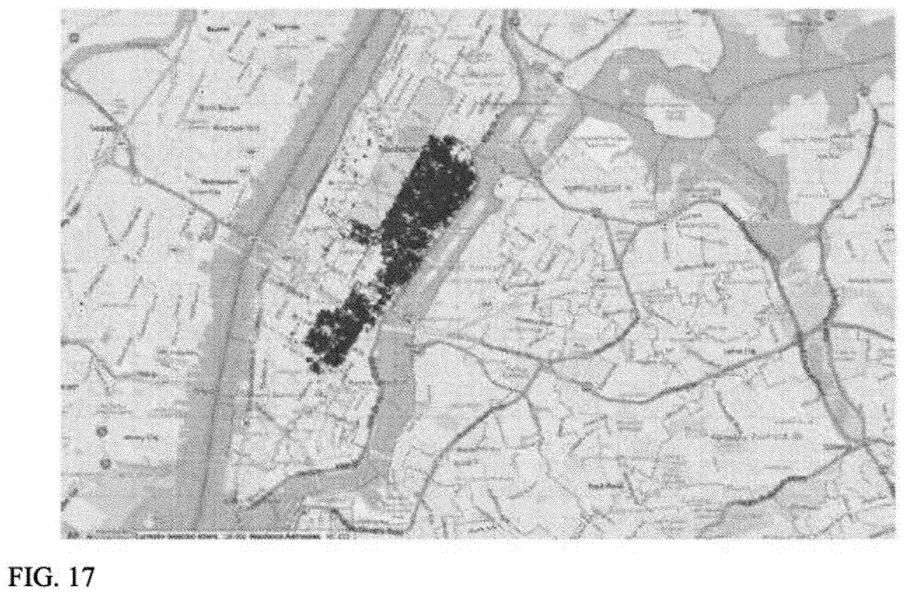

FIG. 17 shows an exemplary map de-identified voters based on demographic data, according to one embodiment. This map shows the demographics based on the voters by voting district, for example, the map shows supporters of State Senate district number 28

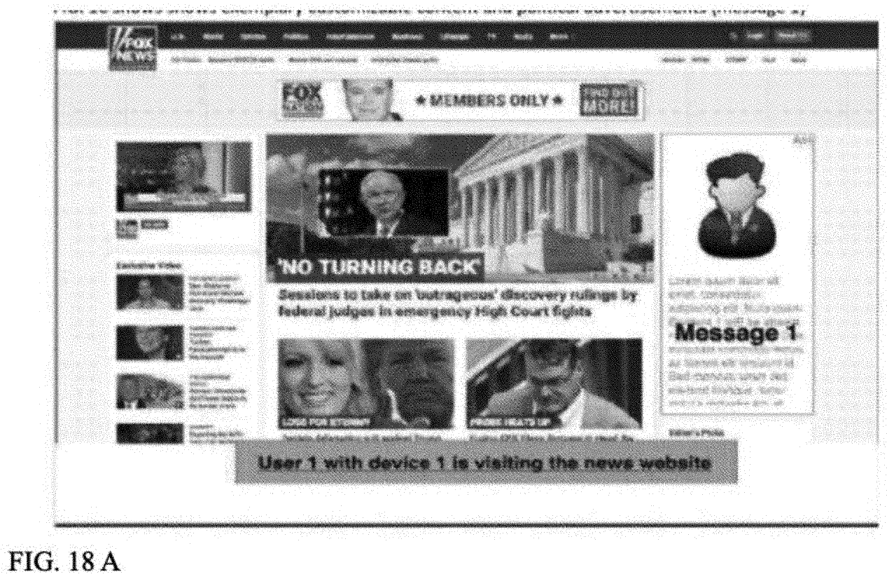

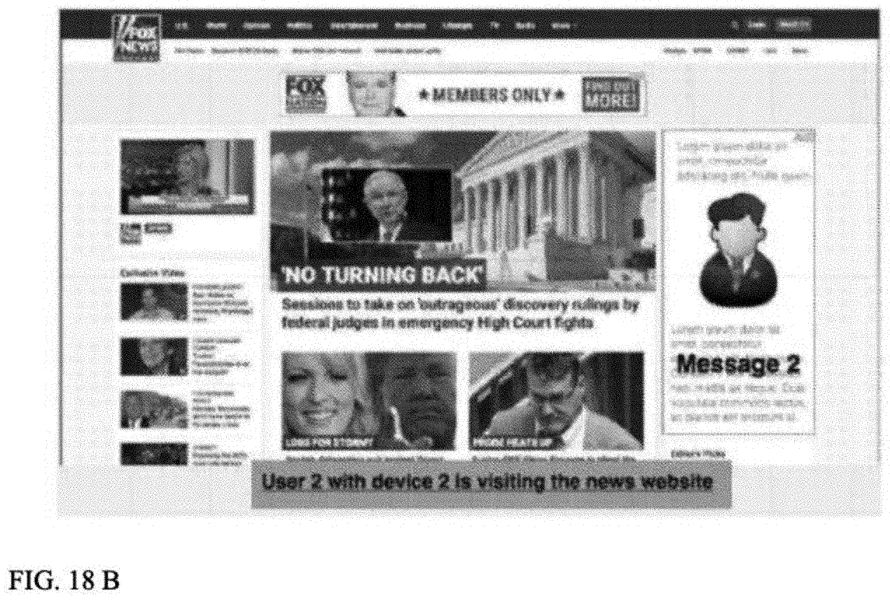

FIG. 18A and FIG. 18 B shows exemplary user interfaces displaying the news website, according to one embodiment. FIG. 18 A shows a news website displayed to a first user ‘user 1’ and FIG. 18 B shows the news website displayed to a second user ‘user 2’. Though the news website is the same, since the target audience are different, the first user ‘user 1’ and the second user ‘user 2’ view different news content. The news content is tailored based on the user profile analyzed.

A system that de-identifies personally identifiable information, translate it into segments and deliver relevant content based on relevant segments and auto-correct itself. User data gets ingested in the platform by direct system integration or partner's data integration. The system generates a relevant segment from multi-touch point attributes such as location visitation, media consumption, series of media consumption, etc. The system matches relevant segments from the content delivery system and score the demand generated segments and create a matching score in real-time. Based on the highest matched score generated by the system, the system pushes relevant content in real-time. The system optimizes content based on NLP and classification of the content. Generate a de-identifiable key for the user to map with segments and deliver content. The system generates segments like Geographical segments, Political Issues, Political Boundaries (constitutional boundaries), Technology, Voter profile, Demographics, Behaviours, and interests, etc from multiple content delivery interaction at the unique de-identifiable key level in real-time. Identify & generate relevant content based content consumption segments. :Deliver identified content to a relevant user based incoming requests. Auto accelerates & decelerate performance of multidimensional segment to improve relevant content delivery. Generate and identify segments that are relevant for ongoing content delivery in real-time. Analyze historical content delivery based on content, system-generated segments, and multidimensional time-series metric data. The system Identify, generate and deliver relevant content. The system pleasures the performance and automatically accelerates/decelerate content delivery in real-time across content distribution channels. Generates segment-based analysis based on multiple metrics and analysis of multiple segment based metrics. Ingest data from a real-tithe feedback :loop that is assigned to a single string of use cases for performance. The system generates aggregated analysis from the provided use case and generates run-time analysis to assign a score for each segment contributing to relevant content delivery and performance. The system's reasoning engine generates analysis from multiple segments based on scores and provides a knowledge graph on contribution factors for the relevant content delivery. The system has the ability to push analysis and knowledge graphs to any integrated data visualization system. The system then pushes the analysis to feedback look to improve segment generation and segment scoring.

Generate analysis by using multiple types of computing machines including but not limited to quantumcomputers and integrated systems, A system that generates scores and matches relevant scores to relevant segments based on real-time demand and relevant content from the integrated content management system. User-generated demand and its segment get its scoring in real-time systems to reduce latency for improved user experience. To achieve the scale of thousands of segment scoring and matching, the system uses a multi-array of machines including quantum computers and uses quantum-enhanced reinforced learning. The system is running real-time multi-segment analysis and NLP on multi-array GPU machines.

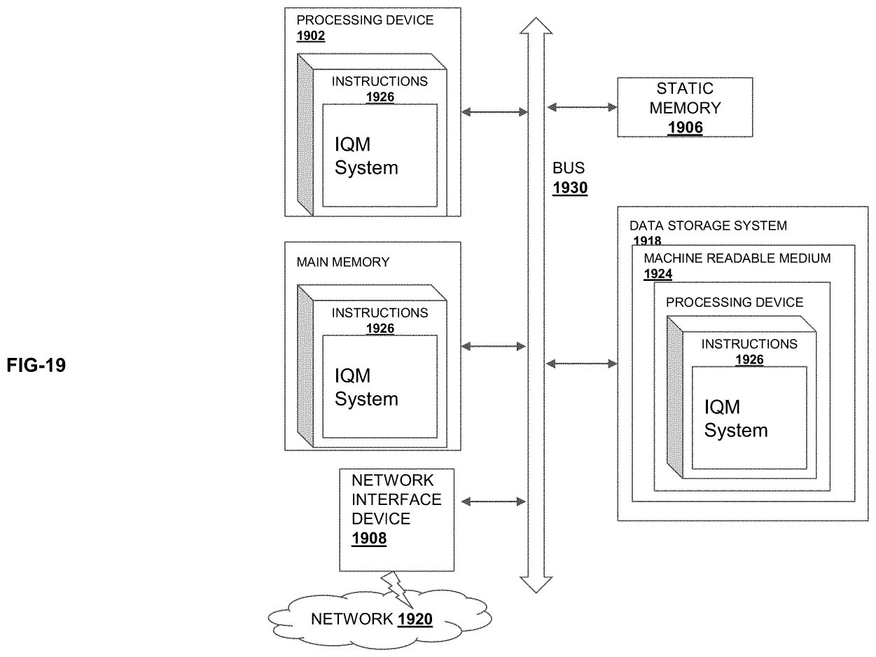

FIG. 19 illustrates an example machine of a computer system 1900 within which a set of instructions, for causing the machine to perform any one or more of the methodologies discussed herein, can be executed. In some embodiments, the computer system 1900 can correspond to a host system configured to perform the operations described in the present disclosure. In an embodiment, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1900 includes a processing device 1902, a main memory 1904 (e.g., read-only memory (ROM), flash memory, dynamic random access memory (DRAM) such as synchronous DRAM (SDRAM) or Rambus DRAM (RDRAM), etc.), a static memory 1906 (e.g., flash memory, static random access memory (SRAM), etc.), and a data storage system 1918, which communicate with each other via a bus 1930. Processing device 1902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1902 can also be one or more special-purpose processing devices such as an application specific integrated circuit (ASIC), a field programmable gate array (FPGA), a digital signal processor (DSP), network processor, or the like. The processing device 1902 is configured to execute instructions 1926 for performing the operations and steps discussed herein. The computer system 1900 can further include a network interface device 1908 to communicate over the network 1920.

The data storage system 1918 can include a machine-readable storage medium 1924 (also known as a computer-readable medium) on which is stored one or more sets of instructions 1926 or software embodying any one or more of the methodologies or functions described herein. The instructions 1926 can also reside, completely or at least partially, within the main memory 1904 and/or within the processing device 1902 during execution thereof by the computer system 1900, the main memory 1904 and the processing device 1902 also constituting machine-readable storage media.

In one embodiment, the instructions 1926 include instructions to implement functionality corresponding to the IQM system. While the machine-readable storage medium 1924 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

In Platform based customer success measurement, the platform provides measurable guidelines that considers the increase or decrease in positive and negative media consumption, campaign wins and an ability to maximize campaign resources and resource waste spent on messages that won't reach open-minded voters. In the course of delivering an ad to a voter via the Platform, the Platform does not intentionally collect information that reveals a voter's real-world identity, such as their name, address, phone number, or Social Security Number. The platform collects data about a voter's computer or device through the use of cookies, web-beacons and other similar technologies. This information is pseudonymous and is not considered personal information in many jurisdictions where the invention operates. In Predicting Polls, predicted election outcomes by altering voter and campaign scenarios are generated. The IQM platform gives insights to positive action on local issues based on historical and real time data as in thus locally intelligent. The IQM platform is emotionally intelligent, where the Surfaced topics will resonate with voter propensity based on social and consumer intelligence. Historical and predictive Location Persona data even shows how people travel in physical space, to guide offline and out-of-home advertising strategies for the segment. The IQM platform is intuitive where the platform's results is plugged into any internal communication channel to deliver dashboards, reports or on demand insights as needed. Accessing detailed consumer and social intelligence data segments with cross-segmenting capabilities to better understand motivations in voter analysis is provided. Gain the ability to compute historical and real-time localized data to produce scenarios and voter insights instantaneously using Voter Micro—Targeting resulting in situational reasoning. Cognitive intelligence to cost-effectively purchase media and data, utilizing Programmatic RTB and voter intelligence algorithms. Some advantages of using the IQM platform is reduced staffing needs, costs and the potential for human errors. When campaigns partner with candidates they develop more compelling messages across the entire digital landscape targeted to their base, yet intelligent enough to persuade influenceable voters to go to the polls. The system is populated with a cross-sectional and representative population data set as well. Users have the option to opt-out of any data collection on any desktop devices due to use of cookies, mobile advertising identifiers and pixel tags.

The advertising delivery and campaign management system enables the candidates themselves to determine the districts that are best suited to run and allowing party leaders to hand select candidates who share positions and beliefs within the various districts and determine the positions and issues that are important to emphasize to a variety of constituent groups.

Increasingly as national, regional and local politics have become more divided, divisive and partisan, a campaigns' success is often determined by a campaign managers ability to effectively mobilize not only their constituent voter base, but to also sway key undecided and independent voters to get to the voting booths and cast a vote in the favour of a candidate. Further, various embodiments are also applicable to the political action committees, advocacy groups, and other organizations seeking a better understanding of a specific constituency and deploying meaningful resources into any specific campaign.

Further, the invention facilitates targeted messaging tailored to a voter or group of voters. Targeting content and delivery methods derived from the analysis of unique political science data sets that can aid in the motivation of an undecided or disenfranchised by aligning messaging with the topics and subject matters relevant to each voter. The system allows for infrequent or non-voters to become politically active and cast a vote that they may not otherwise have cast by pairing them with the votes that are relevant to their positions, biases and beliefs. This ability to sway voters outside of a politician or campaigns known and identified constituent base is often the key deciding factors in a win or loss on Election Day for a candidate, cause or voter initiative.

The current and known systems fail to deliver a true proforma data analytics capability and a solution to create targeted media content based on political science and geographically targeting of constituent populations. The state-of-the-art systems don't address in unison the need for target delivery based on political science, geographic jurisdiction, polling place specificity, voter intelligence sentiment, and proforma display connectivity and capabilities within advanced display environments. The present embodiments address the short fall in technologies that precede it by allowing its users to fully understand and communicate securely and directly to their targeted audiences concurrently.

System that de-identifies personally identifiable information, translate it into segments and deliver relevant content based on relevant segments and auto correct itself. Generate de-identifiable key for user to map with segments and deliver content. System considers segments like Geographical segments, Political Issues, Political Boundaries (constitutional boundaries), Technology, Voter profile, Demographics, Behaviours and interests, etc. Identify relevant content based content segments. Deliver identified content to relevant user demand. System that auto accelerate & decelerate performance of multi dimensional segment to improve relevant content delivery. Generate and identify segments which are relevant. Analyse historical content delivery based on segments and time-frame. Identify, generate and deliver relevant content. Measures the performance and automatically accelerate/decelerate delivery in real-time. The automated method that generate segment based analysis based on multiple metrics and analysis of multiple segment based metrics. The computer implemented method that generate analysis by using multiple type of computing machines including but not limited to quantum computers and integrated systems. System that generate scores and match relevant scores to relevant segments based on real-time demand and relevant content from integrated content management system.

What is claimed is:

1. A computer implemented method of targeted communication, the method comprising:
receive profile information associated with a device code of a user, wherein the profile information is received by direct system integration or partner's data integration;
generate a relevant segment from multi-touchpoint attributes;
match the relevant segment from a content delivery system;
score the matched relevant segment to determine a matching score in real-time;
upon determining the highest matched score generated, push content in real-time, wherein the content is optimized based on natural language processing and classification of the content;
generate a de-identifiable key for the user to map with the relevant segment and deliver the content;
based on the unique de-identifiable key, generate in real-time, relevant segments from multiple content delivery systems;
generate relevant content based on a content consumption segment; and
in response to an incoming request, deliver the identified content corresponding to the user.

2. The computer system of claim 1, further comprising instructions which when executed by the computer cause the computer to:
auto accelerate or decelerate performance of the relevant segment to improve the content delivery.

3. The computer system of claim 1 where generating and identifying segments, further comprising instructions which when executed by the computer cause the computer to:
analyze historical content delivery based on content, system-generated segments, and multidimensional time-series metric data;
identify, generate and deliver relevant content; and
based on the performance measured by the Artifical Intelligence driven programmatic digital transformation platform, automatically accelerate or decelerate content delivery in real-time across content distribution channels.

4. The computer system of claim 1, further comprising instructions which when executed by the computer cause the computer to:
generate automated segment-based analysis based on multiple metrics and analysis of multiple segment based metrics.

5. The computer system of claim 1, further comprising instructions which when executed by the computer cause the computer to:
ingest data from a real-time feedback loop assigned to a single string of use cases for performance;
generate aggregated analysis from the provided use case to generate run-time analysis to assign a score for the individual segment contributing to the relevant content delivery and performance;
generate analysis from multiple segments based on scores and provides a knowledge graph on contribution factors for the relevant content delivery;
send analysis and knowledge graphs to any integrated data visualization system; and
send the analysis to feedback look to improve segment generation and segment scoring.

6. The computer system of claim 1, further comprising instructions which when executed by the computer cause the computer to:
generates scores and match relevant scores to relevant segments based on real-time demand and relevant content from the content management system

7. The computer system of claim 1, wherein the Artifical Intelligence driven programmatic digital transformation platform is running real-time multi-segment analysis and natural language processing on multi-array graphics processing unit machine.

8. A computer implemented method to targeted communication, the method comprising:
receive profile information associated with a device code of a user, wherein the profile information is received by direct system integration or partner's data integration;
generate a relevant segment from multi-touchpoint attributes;
match the relevant segment from a content delivery system;
score the matched relevant segment to determine a matching score in real-time;
upon determining the highest matched score generated, push content in real-time, wherein the content is optimized based on natural language processing and classification of the content;
generate a de-identifiable key for the user to map with the relevant segment and deliver the content;
based on the unique de-identifiable key, generate in real-time, relevant segments from multiple content delivery systems;
generate relevant content based on a content consumption segment; and
in response to an incoming request, deliver the identified content corresponding to the user.

9. The computer implemented method according to claim 8, further comprising:
auto accelerate or decelerate performance of the relevant segment to improve the content delivery.

10. The computer implemented method according to claim 8 where generating and identifying segments, further comprising:
analyze historical content delivery based on content, system-generated segments, and multidimensional time-series metric data;
identify, generate and deliver relevant content; and
based on the performance measured by the Artifical Intelligence driven programmatic digital transformation platform, automatically accelerate or decelerate content delivery in real-time across content distribution channels.

11. The computer implemented method according to claim 8, further comprising:
generate automated segment-based analysis based on multiple metrics and analysis of multiple segment based metrics.

12. The computer implemented method according to claim 8, further comprising:
ingest data from a real-time feedback loop assigned to a single string of use cases for performance;
generate aggregated analysis from the provided use case to generate run-time analysis to assign a score for the individual segment contributing to the relevant content delivery⁻ and performance;
generate analysis from multiple segments based on scores and provides a knowledge graph on contribution factors for the relevant content delivery;
send analysis and knowledge graphs to any integrated data visualization system; and
send the analysis to feedback look to improve segment generation and segment scoring.

13. The computer implemented method according to claim 8, further comprising:
generates scores and match relevant scores to relevant segments based on real-time demand and relevant content from the content management system.

14. computer implemented method according to claim 8, wherein the Artifical Intelligence driven programmatic digital transformation platform is running real-time multi-segment analysis and natural language processing on multi-array graphics processing unit machine.

15. An article of manufacture including a non-transitory computer readable storage medium to tangibly store instructions, which when executed by a computer, cause the computer to:
receive profile information associated with a device code of a user, wherein the profile information is received by direct system integration or partner's data integration;
generate a relevant segment from multi-touchpoint attributes;
match the relevant segment from a content delivery system;
score the matched relevant segment to determine a matching score in real-time;
upon determining the highest matched score generated, push content in real-time, wherein the content is optimized based on natural language processing and classification of the content;
generate a de-identifiable key for the user to map with the relevant segment and deliver the content;
based on the unique de-identifiable key, generate in real-time, relevant segments from multiple content delivery systems;
generate relevant content based on a content consumption segment; and
in response to an incoming request, deliver the identified content corresponding to the user.

16. The article of manufacture of claim 15, further comprising instructions which when executed by the computer cause the computer to:
auto accelerate or decelerate performance of segment to improve the content

17. The article of manufacture of claim 15, further comprising instructions which when executed by the computer cause the computer to:
analyze historical content delivery based on content, system-generated segments, and multidimensional time-series metric data;
identify, generate and deliver relevant content; and
based on the performance measured by the Artifical Intelligence driven programmatic digital transformation platform, automatically accelerate or decelerate content delivery in real-time across content distribution channels.

18. The article of manufacture of claim 15, further comprising instructions which when executed by the computer cause the computer to:
generate automated segment-based analysis based on multiple metrics and analysis of multiple segment based metrics.

19. The article of manufacture of claim 15, further comprising instructions which when executed by the computer cause the computer to:
ingest data from a real-time feedback loop assigned to a single string of use cases for performance;
generate aggregated analysis from the provided use case to generate run-time analysis to assign a score for the individual segment contributing to the relevant content delivery and performance;
generate analysis from multiple segments based on scores and provides a knowledge graph on contribution factors for the relevant content delivery;
send analysis and knowledge graphs to any integrated data visualization system; and
send the analysis to feedback look to improve segment generation and segment scoring.

20. The article of manufacture of claim 15, further comprising instructions which when executed by the computer cause the computer to:
generates scores and match relevant scores to relevant segments based on real-time demand and relevant content from the content management system.
